(19) United States
(12) Patent Application Publication
(10) Pub. No.: US 2009/0235106 A1
(43) Pub. Date: Sep. 17, 2009

(54) METHOD, SYSTEM AND APPARATUS FOR DETERMINING THE POWER SUPPLY REQUIREMENTS OF A DATA PROCESSING SYSTEM

(76) Inventors: John P. Easton, Bradley (GB); Richard M. Appleby, Warsash (GB)

Correspondence Address: HOFFMAN WARNICK LLC, 75 STATE ST, 14 FL, ALBANY, NY, 12207, US

(21) Appl. No.: 12/367,777

(22) Filed: Feb. 9, 2009

(30) Foreign Application Priority Data
Mar. 13, 2008 (EP) 08152688.1

(51) Int. Cl. G06F 1/00

(52) U.S. Cl. 713/340

(57) ABSTRACT

A method, system and apparatus for determining the power supply requirements of a data processing system, wherein the data processing system is associated with a plurality of field replaceable units. A method in accordance with an embodiment includes: identifying, from an electronic label associated with a field replaceable unit, a unique identifier and a power supply requirement of the field replaceable unit; identifying an electronic enclosure label associated with a data processing system; associating the electronic label of a field replaceable unit with the electronic enclosure label of the data processing system; instructing the electronic enclosure label to calculate the power supply requirement of the data processing system from the identified power supply requirement of the associated field replaceable unit associated with the electronic label.

### FIELD OF THE INVENTION

The invention relates to the field of data processing systems. In particular, the present invention relates to a method, apparatus and system for determining the power supply requirements of a data processing system.

### BACKGROUND OF THE INVENTION

A data processing system typically comprises a ‘label’ located towards the back of the data processing system's external casing which provides information concerning the power consumption requirements of the data processing system. Often, the power supply consumption information is required by national law in order to satisfy safety regulations.

One example of a data processing system is a server. The server typically comprises a number of individual electronic components which interface and interact with each other in order for the server to perform many different types of functions. Each one of the electronic components requires a supply of power in order to operate. A server can be extended and modified by adding or substituting additional electronic components. The power supply requirement information displayed on the label of the server's external casing is often inaccurate because it reflects the maximum power consumption of the server in its maximum configuration, i.e., with the maximum number of electronic components installed. Often, however, a server operates in a manner which is below the maximum server configuration.

Another example, of inaccurate power consumption is when a hard disk drive initializes when the server is ‘booting-up’. On initialization the hard drive consumes four to five times more power then when it is running under normal operating conditions. Also, as a server may be operable with a large number of hard disk drives, it is clear to see why the power supply requirement information can be inaccurate.

The information displayed on the label is often used by planners, installers, and other professionals concerned with the safety, consumption, and use of electrical power. When data processing systems are installed, it is often a requirement that the supply of power provided to the data processing system matches the requirements displayed on the label. Because the information displayed on the label is typically inaccurate, this often results in the power supply being significantly over-configured for the data processing system. When this problem is magnified across multiple servers, in a server rack system, the server rack power supply is also significantly over-configured. Consequently the power consumption for an entire data center containing multiple server racks of multiple servers is over configured. These multiple levels of power‘over-configuration’ result in a significant over-provisioning of potentially scarce power resource. In an environmentally concerned future, being able to accurately determine, plan and provision power supply requirements will become a key step towards delivering, and using, electrical power more appropriately in a data center.

### SUMMARY OF THE INVENTION

Viewed from a first aspect, the present invention provides a method for determining the power supply requirements of a data processing system, wherein the data processing system is associated with a plurality of field replaceable units, the method comprising: identifying, from an electronic label associated with a field replaceable unit, a unique identifier and a power supply requirement of the field replaceable unit; identifying an electronic enclosure label associated with a data processing system; associating the electronic label of a field replaceable unit with the electronic enclosure label of the data processing system; instructing the electronic enclosure label to calculate the power supply requirement of the data processing system from the identified power supply requirement of the associated field replaceable unit associated with the electronic label.

The present invention also provides a method wherein a plurality of electronic labels are associated with an electronic enclosure label and the sum of the power supply requirements of the data processing system is calculated from each of the power supply requirements of each of the associated field replacements units associated with an electronic label.

The present invention also provides a method wherein an electronic enclosure label associated with a data processing means is associated with a further electronic enclosure label associated with an enclosure means.

The present invention also provides a method further comprising instructing the further electronic enclosure label to calculate the total power supply requirements of the data processing system from each of the associated electronic enclosure labels.

The present invention also provides a method further comprising displaying the total power supply requirements in a display window of an electronic enclosure label.

The present invention also provides a method wherein the electronic enclosure label is associated with a server.

The present invention also provides a method wherein the electronic enclosure label is associated with an enclosure means.

Viewed from a second aspect, the present invention provides a system for determining the power supply requirements of a data processing system, wherein the data processing system is associated with a plurality of field replaceable units, the system comprising: an electronic enclosure label for associating with at least one of a data processing means and an enclosure means; an electronic label for associating with a field replaceable unit of the data processing system; and a reader device for identifying the power supply requirements of the field replaceable unit from an electronic label associated with the field replaceable unit, associating the electronic label with an electronic enclosure label, updating electronic enclosure records with the power supply requirements of the field replaceable unit, and calculating the total power supply requirements of the data processing system from the electronic enclosure records.

Viewed from a third aspect, the present invention provides an electronic enclosure label comprising storage means for storing power supply requirement information associated with a field replaceable unit, a processor means for calculating the sum of the power supply requirement associated with the field replaceable unit and a display means for displaying the calculated power supply requirement of the associated field replaceable unit.

Viewed from a fourth aspect, the present invention provides an electronic label comprising storage means for storing product identification data and power supply requirement data associated with a field replaceable unit.

The present invention provides an electronic label wherein the electronic label further comprises a transceiver means for transmitting product identification data and power supply requirement data to a requesting electronic enclosure label.

Viewed from a fifth aspect the present invention provides a computer program product loadable into the internal memory of a digital computer, comprising software code portions for performing, when the product is run on a computer, to carry out all the steps of the method as described above.

### BRIEF DESCRIPTION OF THE DRAWINGS

Embodiments of the invention are described below in detail, by way of example only, with reference to the accompanying drawings.

FIG. 1 is a block diagram of a data processing unit in which the present invention may be embodied.

FIG. 2 is a block diagram of an electronic label associated with a field replaceable unit (FRU) in which an embodiment of the present invention my be implemented.

FIG. 3 is a block diagram of an electronic enclosure label in which an embodiment of the present invention may be implemented.

FIG. 4a is a block diagram of a reader device operable with the electronic label of FIG. 2 and the enclosure electronic label of FIG. 3.

FIG. 4b is a block diagram showing hierarchical associations recorded by the reader device of FIG. 4a.

FIG. 5 is a flow chart detailing the operational flow of an embodiment of the present invention.

FIG. 6a is a block diagram showing the characteristic of the electronic label having an associated value.

FIG. 6b is a block diagram explaining the electronic label of FIG. 6b in more detail.

### DETAILED DESCRIPTION OF THE INVENTION

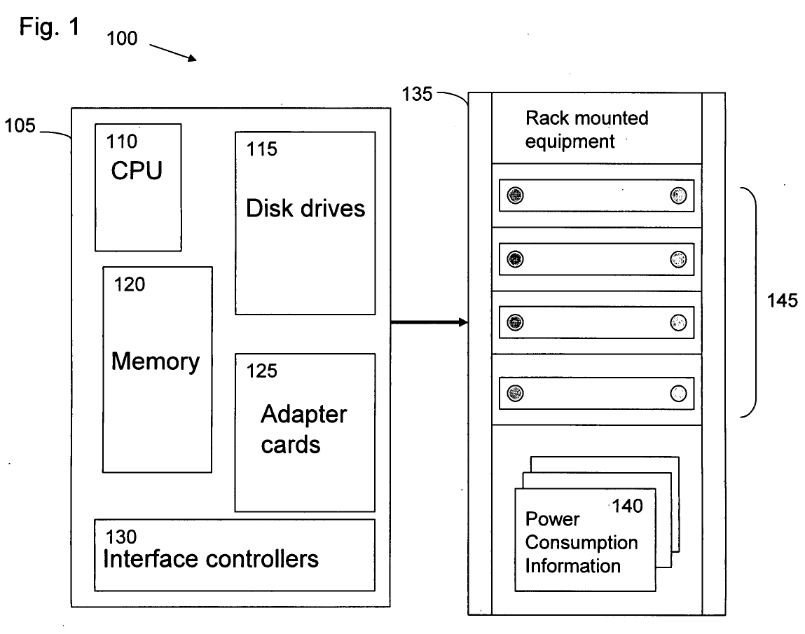

FIG. 1 shows a block diagram of an illustrative data processing system 100 as would be found in a server rack mounted system 135 or other form of enclosure means. In this example the data processing system 100 is a server 105, but the data processing system 100 can be any type of data processing means which is configurable and extendible by the installation of addition electronic components. The enclosure means can be any type of enclosure means that can store or comprise electrical equipment.

The data processing system 100 comprises many types of field replaceable units (FRU) 110, 115, 120, 125, 130. A FRU is a circuit board, a part, an assembly, or other form of electronic component that can be removed from the data processing system and replaced by another electronic component.

In the example of FIG. 1 a FRU comprises a CPU 110, one or more banks of memory 120, one or more hard disk drives 115, one or more adapter cards 125, such as a network card, a graphics card, or a sound card, etc., one or more interface adapter cards 130, or any other type of FRU that interfaces with a motherboard or the like.

Each FRU 110, 115, 120, 125, 130 requires power to be supplied to it. The amount of power supply required varies from one FRU 110, 115, 120, 125, 130 to another. For example, a typical hard drive may require 15 W to 30 W of power, a motherboard, 50 W to 100W, RAM 15 W per 1 GB, and a CPU fan about 3 W of power. Information about how much power each FRU 110, 115, 120, 125, 130 requires can be obtained either from a manufacturer (some manufacturers supply tables informing of the power supply requirements of each FRU for their server systems) or each FRU 110, 115, 120, 125, 130 may have its own label 140 displaying information about its power supply requirements.

One such type of label that can be used to display this information is an electronic label. An electronic label can display information that is electronically written to the label. For example, product information associated with a specific FRU. The electronic label may be manufactured from any suitable material that can be electronically written and that will maintain the last display state when power is removed form the label. The electronic label may also comprise a memory for storing product related information and display means for displaying information stored in the memory. The electronic label may also take the form on an RFID tag or other type of electronic means that is capable of storing product related information and transceiver means for receiving updated product information form other electronic labels and for transmitting product information to other requesting electronic labels.

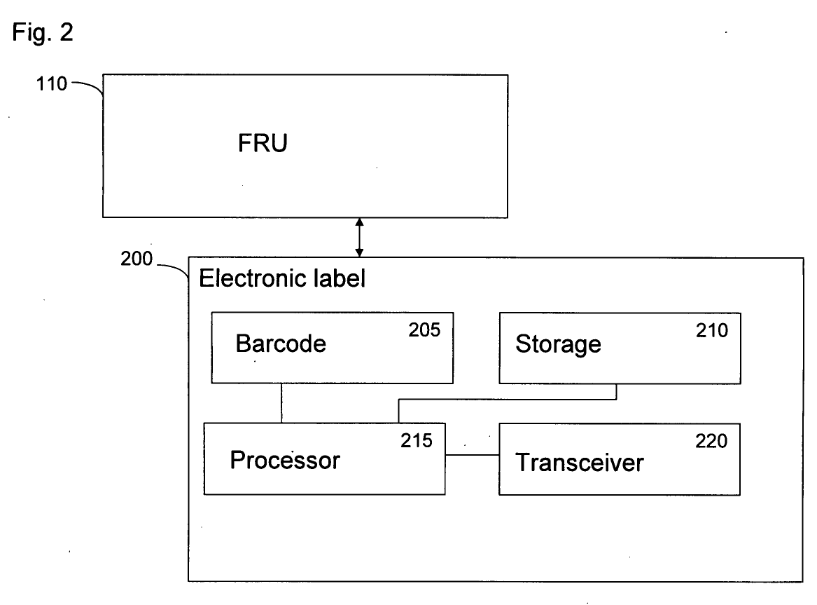

FIG. 2 shows an illustrative embodiment of an electronic label which is operable for displaying information specific to a FRU 110, 115, 120, 125, 130 that it is associated with. The electronic label displays, for example, a human readable form of information, such as a part number and the power supply requirements of the FRU and a machine readable form of information, such as a barcode.

In order to provide the benefits of an embodiment of the present invention, the electronic label described above comprises several enhancements. These are shown in FIG. 2.

The electronic label 200 comprises a machine readable form of information 205 comprising the power supply requirements of the FRU 110-130 and a unique identifier associated with the FRU 110-130, storage means 210 for storing information associated with the FRU, such as the FRU's 110-130 unique identifier, the FRU's 110-130 part number and the FRU's 110-130 power supply requirements, a processor 215 and a transceiver 220 for transmitting information stored in the storage means 210 to other requesting electronic labels such as an electronic enclosure label. Each electronic label 200 may comprise attachments means for attaching the electronic label to a FRU 110-130. The electronic label 200 may be attached to a FRU 110-130 at the time of manufacture, or the electronic label 200 may be attached at a time when the FRU 110-130 is being installed in a server system 105.

If the electronic label 200 is attached at the time the FRU 110-130 is installed into the server system 105, the processor component 215 may provide means for accepting input associated with the power supply requirements of the FRU 110-130 from a reader device. The power supply requirement information is stored in the storage means 210 of the electronic label 200.

Alternatively, the electronic label 200 can transmit to a reader device pre-programmed power supply requirement information via the transceiver means 220.

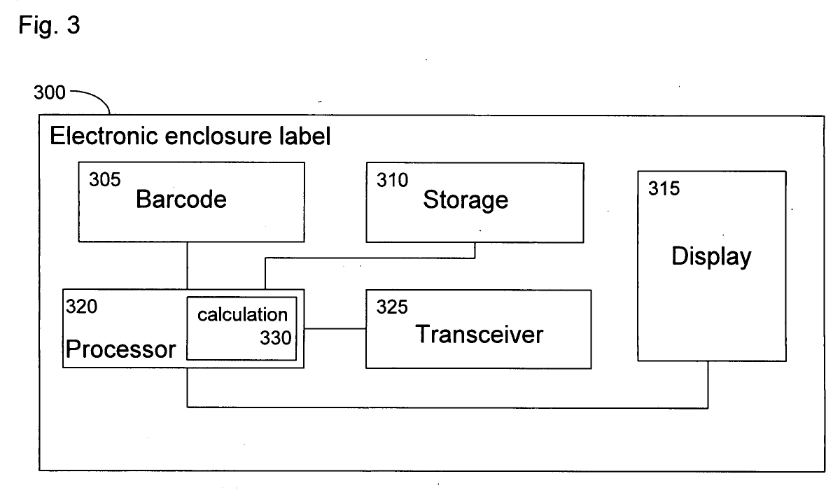

Another type of label is shown with reference to FIG. 3. This type of electronic label is an electronic enclosure label which provides the function of storing power supply requirement information associated with each FRU 110-130 installed in a server system 105 and processor means 320 for calculating the sum of the combined power supply requirements of all of the FRUs 110-130 associated with the server system 105. The electronic enclosure label 300 also comprises a display means 315 for displaying the calculated power supply requirements.

An electronic enclosure label 300 may also be associated with an enclosure means 135. An enclosure means, in the example of a server rack 145, may have a plurality of servers 105 located in the server rack 145. Thus each server 105 comprises an electronic enclosure label 300 displaying the calculated power supply requirements of each of the FRUs 110-130 installed and an electronic enclosure label 300 associated with the enclosure means 145 for calculating and displaying the sum of the power supply requirements of all of the servers 105 associated with the server rack 145.

An electronic enclosure label 300 is a modification of the electronic label 200 of FIG. 2. The modification comprises a storage means 310 further comprising means for maintaining a log of data associated with each FRU that is associated with a server 105 or an enclosure means 135, a processor 320 further comprising means for calculating the sum of the power supply requirements for each of the FRU's associated with a server 105 or the sum of the power supply requirements of all of the servers 105 located in a server rack 145 of an enclosure means 135 and a display means 315 for displaying the computed total as calculated by the calculating means.

The electronic enclosure label 300 comprises a number of components that interface and interact with each other in order to display the total power consumption of all the FRUs associated with a server or an enclosure means 135.

An electronic enclosure label 300 may comprise the following components: a machine readable form of information 305 for displaying information identifying the server 105 or the enclosure means 135 associated with the electronic enclosure label 300, a processor means 320 further comprising calculation means 330 for calculating the total power consumption of all of the FRU's associated with a server 105, or, all of the servers 105 associated with an enclosure means 135, storage means 310 for maintaining a log of all FRUs associated with a server 105 or each of the servers associated with an enclosure means 135 and a display means 315 for displaying the total power consumption of all the FRUS associated with a server 105 or all of the servers associated with an enclosure means 135. A transceiver means 325 allows the receiving and transmitting of information from the storage means 310 thus also performing the function of an RFID tag.

Thus each electronic enclosure label 300 may store the following information:
For an electronic enclosure label 300 associated with a server 105:
   For each FRU installed in a server:
      A unique identifier associated with a FRU 110-130 and the FRU's power supply requirements wherein the information is obtainable from the electronic label 200 associated with each of the installed FRUs 110-130; and
      The calculated combined power supply requirements for each of the FRUs 110-130 installed in the server 105.
   For each server 105 associated with an enclosure means 135:
      A unique identifier associated with the server 105, and the server's calculated power supply requirements obtainable from the calculated total power supply requirements computed by the electronic enclosure label 300 associated with the server 105;
      When there is more than one server 105 in an enclosure means 135, the hierarchical associations between electronic enclosure labels 300 of a server 105 and the enclosure means 135; and
      The sum of the power supply requirements of the enclosure means 135, calculated from each of the computations stored on each of the electronic enclosure labels 300 associated with each of the servers 105 associated with the enclosure means 135.

Variants of the type of information and whether the totality of information is stored on each electronic enclosure label 300 or only a required subset can be realized by a person skilled in the art without departing from the scope of the invention.

In order for the electronic label 200 of FIG. 2 and the electronic enclosure label 300 of FIG. 3 to interact which each other so that an electronic enclosure label 300 can display the total power supply requirements for all of its associated components, a reader device is used.

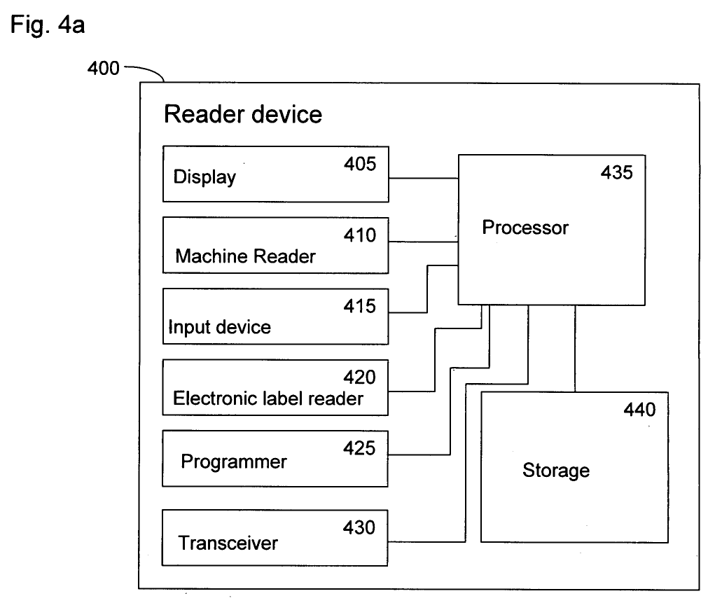

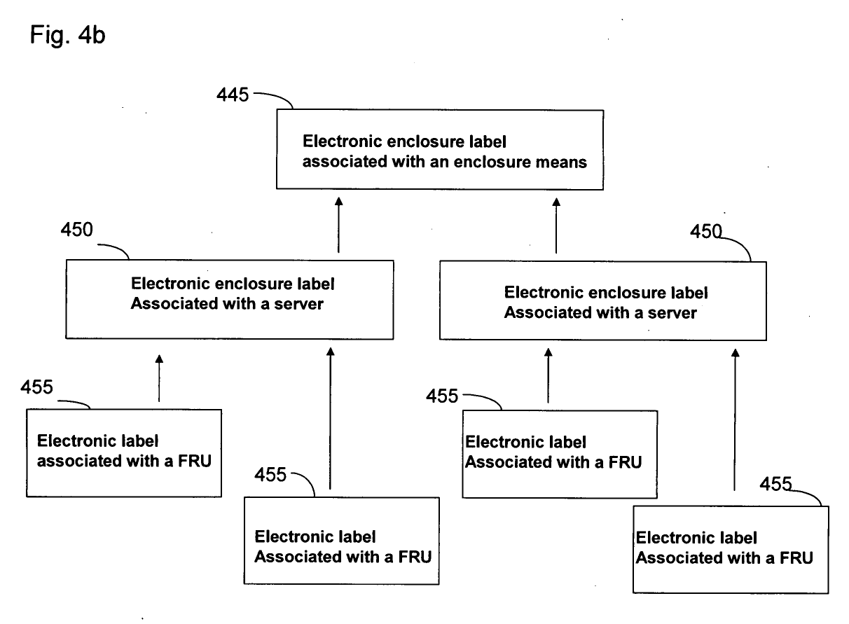

A reader device is shown with reference to FIG. 4a. The function of the reader device 400 is to read information stored on an electronic label 200 and transmit this information to an electronic enclosure label 300. The reader device 400 also performs the function of associating one or more electronic labels 200 with an electronic enclosure label 300 and one or more electronic enclosure labels 300 with further electronic enclosure labels 300.

This concept is explained with reference to FIG. 4b. Firstly, a number of electronic labels 455 are associated with a number of FRUs. In turn each one of these electronic labels 455 is, via the operation of the reader device 400, associated with an electronic enclosure label 450, which is associated with a server. Then, moving up the hierarchy, each of the electronic enclosure labels 450 associated with the servers is associated with an electronic enclosure label 445 of an enclosure means, via the operation of the reader device 400.

The components of the reader device 400 are as follows: a display means 405 for displaying input and output information from and to an electronic label 200 and an electronic enclosure label 300, a machine readable information form reader 410 for reading power consumption and product identification information from for example, a barcode on an electronic label 300 or on a electronic enclosure label 300, an input means 415 such as a keyboard for inputting information into the reader device 400, a transceiver 430 for reading and transmitting information to and from the transceivers of the electronic labels 200 and the electronic enclosure labels 300, a programmer means 425 for associating an electronic label 200 with an electronic enclosure label 300 and an electronic enclosure label 300 with a further electronic enclosure label 300 as described with reference to FIG. 4b, a processor means 435 for processing all of the received information and a storage means 440 for storing a log of the hierarchical relationships of FRUs, servers and enclosure means (FIG. 4b) and the total power supply requirements as computed by each of the electronic enclosure labels 300.

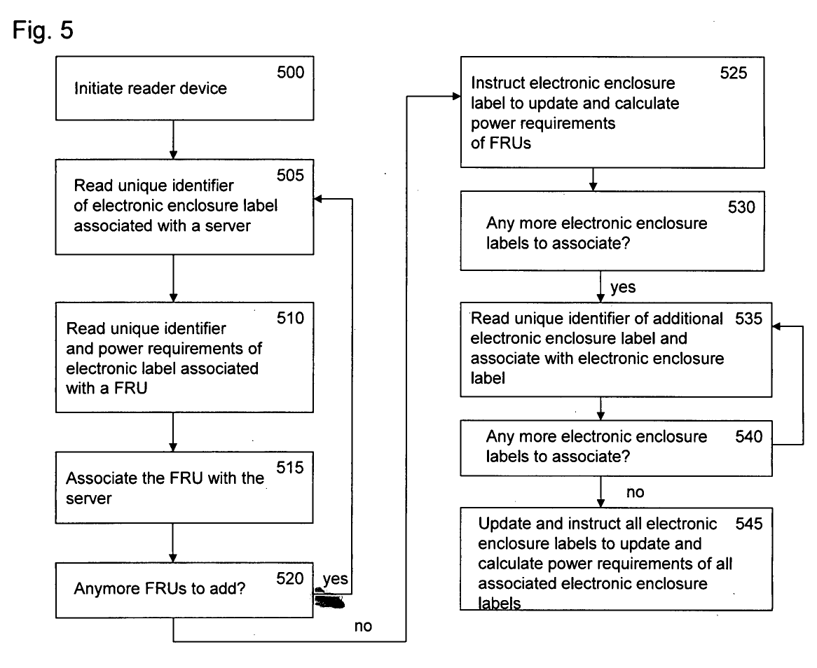

Moving on to FIG. 5, a flow chart is shown detailing the interaction between an electronic label 200 associated with a FRU 110, 115, 120, 125, 130, an electronic enclosure label associated 300 with a server 105 and an electronic enclosure label 300 associated with an enclosure means 135. The example that follows depicts the situation where a number of FRUs are being installed into a server system for the first time.

At steps 500 and 505, the reader 400 scans the barcode located on the electronic enclosure label 300 in order to identify the server 105 that is to be associated with a number of FRUs 110-130. The unique id of the server 105 is stored in the storage means 440 of the reader device 400.

Next, at step 505, a number of FRUs are installed into the server system 105. For each FRU 110-130 being installed, the reader component 410 scans the FRU's barcode on its associated electronic label 300. The barcode identifies what type of FRU 110-130 it is and its power supply requirements.

Alternatively, the FRU's power supply requirements can be located from a database stored in the reader's storage means 440 or some other storage means located on a server 105 etc. As each FRUs electronic label 200 is read, the programmer component 425 associates each FRUs unique identifier with the unique identifier of the server 105, at step 510. The association information is stored in the reader device's 400 storage means 440 and the programmer component 425 writes this information to the storage means of the electronic enclosure label 300 associated with the server 105. Thus the electronic enclosure label 300 stores a log of each of the electronic labels 200 associated with the server 105 and the power supply requirements of each of the FRUs associated with the server 105.

At step 515, this process of reading information from an electronic label 200 associating the FRU associated with an electronic label 200 to a server 105 and storing the information in the reader 400 and on the electronic enclosure label 300 is carried out until all FRUs 110-130 have been installed in the server 105, at step 520.

Once completed the, programmer component 425 informs the electronic enclosure label 300 that there are no more FRUs 110-130 to associate with the server 105 and instructs the electronic enclosure label 300 to calculate the total power supply requirements for all FRUs 110-130 associated with it. The calculation is displayed via the display means of the electronic enclosure label 300, at step 525. If there are further servers to be configured steps 505 to 520 are repeated.

At step 530 a determination is made as to whether there are any further servers 105 to be configured. If the determination is positive, the reader device 400 reads the unique identifier of additional electronic enclosure label 300 and associates these with the electronic enclosure label 300 of the enclosure means 135 at step 535.

Once the server rack 145 is fully configured, the reader device 400 reads the storage means of each of the electronic enclosure labels 300 associated with each of the servers 105 to determine the unique identifier of each of the servers 105 and the power supply requirements of each server 105, as determined in step 540.

This information is transmitted to the electronic enclosure label 300 by the reader device 400. The electronic enclosure label 300 stores this information in its log. Once all information has been stored in the log, the electronic enclosure label 300 is instructed to process this information in order to calculate the total power supply requirements for all the servers installed in the associated enclosure means. The calculation is displayed via the electronic enclosure label's display means 315 at step 545.

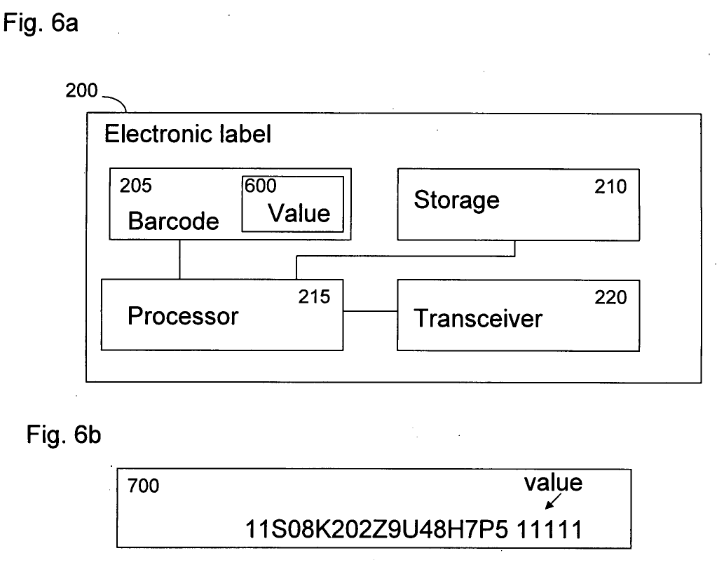

In another embodiment shown in FIGS. 6a and 6b, a number of electronic labels 200, are given a value 600, the value 600 is associated with a number of watts for example. For example, an electronic label 200 may be given a value of the number ‘five’ which is equivalent to five watts, a value ‘ten’ which is equivalent to ten watts, etc. Thus, when the reader device 400 reads the barcode associated with a FRU 110-130 to identify the FRU's unique identifier, the reader device 400 performs a lookup in its storage means in order to identify the power supply requirements of the FRU 110-130. Then, via the display means 405 of the reader device 400, the reader displays how many electronic tags are required of a particular value 600 to represent the power supply requirements of the FRU 110-130. For example if the power supply requirements of a FRU 110-130 are twenty five watts, this value 600 can be represented via selecting two ten watt electronic tags and one five watt electronic tag. These electronic labels 200 are then attached to or associated with the FRU 110-130 in question. The electronic enclosure label 300 in this embodiment, searches via its transceiver component 430 for electronic labels 200 not already logged in its storage means 440. All electronic labels 200 will broadcast, via their transceiver component 220, their unique identifiers. The electronic enclosure label 300 will search for unique identifiers not already associated with it, i.e., identifiers not already logged in its storage means.

Once the unique identifiers have been detected and logged in the data store, the electronic enclosure label 300 will automatically calculate the total power supply requirements of each of the FRUs 110-130 associated with it, i.e., associated with the server 105. The process for each electronic enclosure label 300 to display the total power supply requirements for each of its associated servers 105 or for an electronic enclosure label 300 to display the total power supply requirements for each server 105 associated with an enclosure means 135 is then performed as per steps 525 to 545 of FIG. 5.

It will be clear to one of ordinary skill in the art that all or part of the method of the preferred embodiments of the present invention may suitably and usefully be embodied in a logic apparatus, or a plurality of logic apparatus, comprising logic elements arranged to perform the steps of the method and that such logic elements may comprise hardware components, firmware components or a combination thereof.

It will be equally clear to one of skill in the art that all or part of a logic arrangement according to the embodiments of the present invention may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

It will be appreciated that the method and arrangement described above may also suitably be carried out fully or partially in software running on one or more processors (not shown in the figures), and that the software may be provided in the form of one or more computer program elements carried on any suitable data-carrier (also not shown in the figures) such as a magnetic or optical disk or the like. Channels for the transmission of data may likewise comprise storage media of all descriptions as well as signal-carrying media, such as wired or wireless signal-carrying media.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The present invention may further suitably be embodied as a computer program product for use with a computer system. Such an implementation may comprise a series of computer-readable instructions either fixed on a tangible medium, such as a computer readable storage medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

In one alternative, the preferred embodiment of the present invention may be realized in the form of a computer implemented method of deploying a service comprising steps of deploying computer program code operable to, when deployed into a computer infrastructure and executed thereon, causes said computer system to perform all the steps of the method.

It will be clear to one skilled in the art that many improvements and modifications can be made to the foregoing exemplary embodiments without departing from the scope of the present invention.

1. A method for determining power supply requirements of a data processing system, wherein the data processing system is associated with a plurality of field replaceable units, the method comprising:
identifying, from an electronic label associated with a field replaceable unit, a unique identifier and a power supply requirement of the field replaceable unit;
identifying an electronic enclosure label associated with a data processing system;
associating the electronic label of a field replaceable unit with the electronic enclosure label of the data processing system; and
instructing the electronic enclosure label to calculate the power supply requirement of the data processing system from the identified power supply requirement of the associated field replaceable unit associated with the electronic label.

2. The method as claimed in claim 1, wherein a plurality of electronic labels are associated with an electronic enclosure label and a sum of the power supply requirements of the data processing system is calculated from each of the power supply requirements of each of the associated field replacements units associated with an electronic label.

3. The method as claimed in claim 1, wherein an electronic enclosure label associated with a data processing means is associated with a further electronic enclosure label associated with an enclosure means.

4. The method as claimed in claim 3, further comprising:
instructing the further electronic enclosure label to calculate the total power supply requirements of the data processing system from each of the associated electronic enclosure labels.

5. The method as claimed in claim 1, further comprising:
displaying the total power supply requirements in a display window of an electronic enclosure label.

6. The method as claimed in claim 1, wherein the electronic enclosure label is associated with a server.

7. The method as claimed in claim 1, wherein the electronic enclosure label is associated with an enclosure means.

8. A system for determining the power supply requirements of a data processing system, wherein the data processing system is associated with a plurality of field replaceable units, the system comprising:
an electronic enclosure label for associating with at least one of a data processing means and an enclosure means;
an electronic label for associating with a field replaceable unit of the data processing system; and
a reader device for identifying the power supply requirements of the field replaceable unit from an electronic label associated with the field replaceable unit, the reader device further associating the electronic label with an electronic enclosure label, updating electronic enclosure records with the power supply requirements of the field replaceable unit and calculating the total power supply requirements of the data processing system from the electronic enclosure records.

9. An electronic enclosure label, comprising:
storage means for storing power supply requirement information associated with a field replaceable unit;
processor means for calculating a sum of the power supply requirement associated with the field replaceable unit; and
display means for displaying the calculated power supply requirement of the associated field replaceable unit.

10. An electronic label, comprising:
storage means for storing product identification data and power supply requirement data associated with a field replaceable unit; and
transceiver means for transmitting the product identification data and power supply requirement data to a requesting electronic enclosure label.
